(19) United States
(12) Patent Application Publication
(10) Pub. No.: US 2005/0205674 A1
(43) Pub. Date: Sep. 22, 2005

(54) System and method for tracing agricultural commodities

(75) Inventors: Timothy J. Herrman, College Station, TX (US); Daryl Strouts, Manhattan, KS (US)

Correspondence Address: SPENCER, FANE, BRITT & BROWNE, 1000 WALNUT STREET, SUITE 1400, KANSAS CITY, MO, 64106-2140, US

(73) Assignee: Kansas State University Research Foundation.

(21) Appl. No.: 11/086,151

(22) Filed: Mar. 22, 2005

Related U.S. Application Data
(60) Provisional application No. 60/555,719, filed on Mar. 22, 2004.

(51) Int. Cl. G06F 17/60

(52) U.S. Cl. 235/385

(57) ABSTRACT

The present invention encompasses a system and method for tracing a particular load or series of a bulk agricultural commodity throughout the marketing process. The system includes a plurality of tracing caplets (80), each tracing caplet (80) including encoded information, a scanning device (90) capable of reading the encoded information, and a data retrieval and management system (110) operable to receive and store data, including the encoded information from a tracing caplet (80), concerning the agricultural commodity. One method for tracing agricultural commodities comprises reading information (210) encoded on a caplet contained in an agricultural commodity, and communicating (220) the information and additional data about the agricultural commodity to a data retrieval and management system (110). In another method of the present invention, data concerning an agricultural commodity is received, the data including the location of the agricultural commodity and information from a caplet dispensed into the agricultural commodity, and the data and information are stored in a database.

### CROSS REFERENCE TO RELATED APPLICATIONS

This application claims the benefit of U.S. Provisional Application No. 60/555,719 entitled “Product Tracing and Recall System,” filed Mar. 22, 2004. Priority is claimed thereto pursuant to 35 U.S.C. § 119(e).

### STATEMENT REGARDING FEDERALLY SPONSORED RESEARCH AND DEVELOPMENT

None.

### BACKGROUND OF THE INVENTION

The present invention relates generally to a system and method for tracing products. More specifically, the present invention encompasses a system and method for tracing agricultural commodities utilizing a tracing caplet containing identifying information for the commodity, a scanning device for reading the identifying information on the caplet, and a data retrieval and management system for tracing product movement.

To retain their comparative advantage in the global market and address domestic food safety and quality issues, commodity producers and handlers need to implement a system that can trace commodities back to their source. For example, if a bio-terror or major food safety event occurs, commodity trace back from any point in the marketing chain to the individual field or fields is an essential step in identifying the source of contamination. Additionally, trace back capability will expedite risk management strategies including product recall. Traceability may be defined to mean the ability to trace and follow a food, feed, food-producing substance intended to be or expected to be incorporated into a food or feed, through all stages of production and distribution.

Producers and processors have implemented identity-preserved traceability programs for a variety of reasons. For example, when genetically modified maize was approved for feed use, many dry millers implemented system wide identity-preserved traceability programs to insure that the modified maize did not find its way into consumer products. Currently, identity-preserved traceability programs rely on best management practices, inspection, and record keeping to achieve specified levels of purity and product identity. Thus, one company maintains dedicated commercial elevators to avoid commingling of products. Another company requires that producers maintain field maps that include identification of the crops grown in neighboring fields and confirm that only approved herbicides and insecticides are applied to their commodity. Clearly, the traceability programs currently in use are expensive to maintain, incompatible, difficult to implement, and of questionable reliability.

Accordingly, it is desirable to provide a system and method for tracing agricultural commodities that is inexpensive, scalable to a large marketing system, easy to use, and reliable.

### BRIEF SUMMARY OF THE INVENTION

There is, therefore, provided in the practice of the invention a system and method for tracing a particular batch of an agricultural commodity from field to port. In accordance with one embodiment of the present invention, a system for tracing agricultural commodities comprises a plurality of tracing caplets. Each tracing caplet includes encoded information. The system also includes a scanning device capable of reading the encoded information on the caplets, and a data retrieval and management system operable to receive the caplet information and other data relating to the agricultural commodity. The data, which includes the present location of the commodity and the date and time, and the encoded information from the tracing caplet are stored by the data retrieval and management system, and a medium for that storage is provided. In one aspect of this embodiment, the caplet information is encoded using a bar code inscribed or printed on the caplet. In yet another aspect of this invention, the caplet is an radio frequency identification (“RFID”) tag.

In accordance with another embodiment of the present invention, there is provided a method for tracing agricultural commodities, the method comprising reading information encoded on a caplet contained in an agricultural commodity, and communicating the encoded information and addition data about the agricultural commodity to a data retrieval and management system.

In yet another embodiment of the invention, there is provided a method for tracing an agricultural commodity, the method comprising receiving data concerning an agricultural commodity, the data including the location of the agricultural commodity, and information from a caplet dispensed into the agricultural commodity, and storing the data and information in a database.

### BRIEF DESCRIPTION OF THE DRAWINGS

Further features of the present invention will become apparent to those skilled in the art to which the present invention relates from reading the following description with reference to the accompanying drawings, in which:

FIG. 1 is a block diagram showing one embodiment of the system of the present invention;

FIG. 2 is a flow diagram that includes the steps from one embodiment of the method of the present invention and, in particular, when the caplets are inscribed with a bar code; and

FIG. 3 is a flow diagram that includes various steps from a second embodiment, that is when the caplet is an RFD) tag, of the method of the present invention.

### DETAILED DESCRIPTION OF THE INVENTION

The present invention includes a system and method for tracing agricultural commodities. The system is inexpensive and easy to implement and use. Additionally, the system is scalable to large marketing systems. The system and method of the present invention will be described using wheat as the commodity. It should be understood and appreciated that the system and method are equally applicable to other commodities.

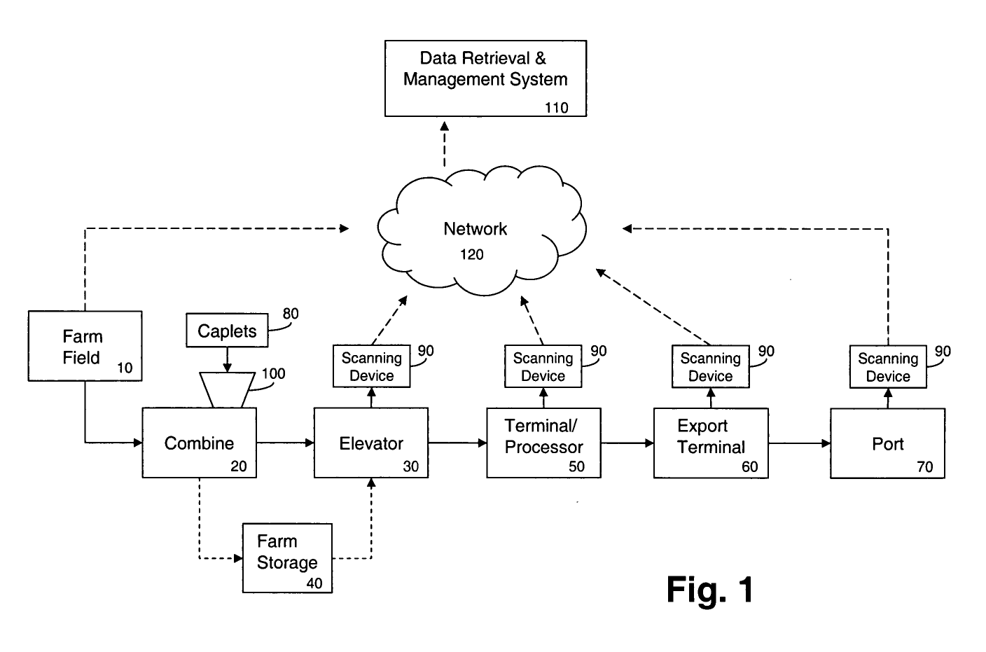

Turning now to the figures, FIG. 1 shows one embodiment of the system of the present invention in a large marketing/distribution system. Regarding the marketing/distribution system, initially wheat is grown in a farm field 10 by a wheat producer. The wheat is harvested through the use of a combine 20 and unloaded at an elevator 30 in bulk. Alternatively, the wheat is unloaded from the combine 20 to farm storage 40 and is transported to the elevator 30 at a later date. From the elevator 30, the wheat is transported to a terminal/processor 50 usually by truck or rail. Next, as desired, the wheat is transported in bulk to an export terminal 60 and, thereafter, it is transported to a port 70. Typically, the wheat is transported to the export terminal 60 by rail or barge and to the port 70 by a vessel.

The present invention includes tracing caplets 80 containing information used to identify the wheat from an individual field or location. The tracing caplets 80 are distributed into the bulk grain and, in one embodiment, possess physical and chemical properties similar to wheat. Thus, in one embodiment, the caplets 80 will be made from a wheat material such as whole wheat ground using a Jacobson hammer mill equipped with a 2 mm screen opening, hard red winter wheat straight grade flour, farina (purified middlings of hard red winter wheat flour), or semolina (large particles of durum wheat). All products used in the formation of the caplets 80 are food-grade materials that will not pose potential hazards to people. Once in the wheat, these caplets 80 do not require any additional precautions other than the safety measures already in use when handling grain. Additionally, it will not be necessary to remove any caplets 80 remaining in the wheat prior to processing because the caplets 80 do not pose any food safety threat and will not affect the functional properties of the grain.

The caplets 80 according to this embodiment are formed using a die and applying thermal processing and pressure to have a density similar to a wheat kernel so that they will be easily incorporated with bulk wheat grain. The caplets 80 have a different shape and length when compared to a typical wheat grain which allows the caplets 80 to be removed with a standard grain cleaner. In one embodiment, the caplets 80 are pellets. In one embodiment, the caplets 80 are pellets having the following physical properties: a length of 6 mm; a diameter of 4 mm; a weight of 87 mg; and a density of 1.15 g/cm³. One device suitable for manufacturing pellets is the Model 1000 series “Master HD” pellet mill by the California Pellet Mill Company of Crawfordsville, Ind.

After the caplets 80 are formed, they are sprayed in one embodiment with a food grade protective multi-dextrin coating. Many commercially available multi-dextrin coating products, such as products provided by the Grain Processing Corporation of Muscatine, Iowa, would provide a sufficient coating. Several application methods may be used including aqueous film coating using perforated pan technology, pan coating, and dipping.

In another embodiment, the caplets 80 are made from carbohydrate or non-protein, non-allergenic ingredients. These caplets 80 are “universal” caplets, that is, the caplets are usable in any type of commodity. In one embodiment, these caplets are made from corn syrup and sugar.

The caplets 80 will be encoded with information in a manner so that the information is readable by a scanning device 90. In one embodiment, the caplets 80 are encoded with a bar code provided on the caplet, and the scanning device 90 is a handheld bar code reader. One suitable bar code reader is an IT4088SR bar code reader manufactured by Hand Held Products Corporation, Skaneateles Falls, N.Y. Though factual data regarding the product is encoded and provided on the caplets in some embodiments, the information serves as a pointer to data regarding the product with which the caplet is placed. Thus, in the present embodiment, the information contains only a caplet identifier.

In another embodiment, the caplets are a Radio Frequency Identification (RFID) tag. In one embodiment an RFID tag is manufactured with material that is not harmful to humans or animals if ingested. However, to decrease the impurities, the RFID tag is removed in one embodiment prior to processing. In one embodiment, the RFID tags also are manufactured within the same size limits mentioned above so that these caplets also can be easily separated from the remaining grain. When the caplet information is encoded on the RFID tag, the scanning device 90 is an RFID reader.

Wheat producers will receive their allotted share of tracing caplets 80 prior to harvest. The producer is responsible for coordinating the caplets 80 to the designated field, or providing the caplets 80 to the harvesters who will be responsible for the wheat collection. There are several points at which delivery of the caplets 80 is possible. The caplets 80 can be introduced between the combine's final cleaning process and the grain bin. The clean grain lower cross auger, vertical elevator, and bin filling auger are also possible locations for delivery of the caplets 80.

Continuing with FIG. 1, in one embodiment, the tracing caplets 80 are distributed into the grain by means of a dispensing mechanism 100 located in the unloading auger of the combine 20 as the grain is transferred from the combine 20 to a truck or grain cart. Typically, grain flow rate is relatively constant during the unloading process. Thus, when the caplets 80 are dispensed at a constant rate, a uniform distribution of caplets in the grain is achieved.

The dispensing mechanism 100 in this embodiment includes a commercially available seed dispenser with fluted-feed grain drill cups and an electrically powered metering mechanism. The dispenser 100 is attached to the combine 20 by welding and/or clamping the dispenser 100 to the metal frame of the combine 20. One possible position for the dispenser 100 is just downstream of the upper gearbox that connects the vertical unloading auger to the horizontal auger. Placement of the dispensing mechanism 100 in this position typically requires only the removal of an inspection plate. No permanent modifications are required. In one embodiment, the caplets 80 are dispensed by the dispensing mechanism 100 into a plastic pipe which delivers the caplets into the grain stream close to the unloading auger.

The dispenser 100 should be sized so that it need only be filled once daily in order to avoid interruption of the harvest. Thus, in one embodiment, the dispenser 100 has a 30 liter capacity which would contain about 23.1 kg of the caplets 80 described above. For a discharge rate of 0.015% of caplets on a mass basis, this number of caplets would mark approximately 154,000 kg of wheat which falls roughly in the range of a typical combine's daily capacity.

The dispenser 100 is powered by a 12 volt DC motor that is wired to operate whenever the unloading auger is engaged. Because the current required for the motor is significant in comparison to the current needed to operate the hydraulic valves of the auger, it is not possible generally to pass the dispenser current through the switch that activates the unloading auger. Therefore, an appropriate relay configured to pass current when the unloading auger is engaged is utilized.

In one embodiment, the dispenser 100 is equipped with a cleanout door (not shown) to allow the discharge of unused caplets which will facilitate rapid changing of caplets 80 between fields or farms. The generally benign nature of the caplets 80 should allow excess caplets to be discharged in the field for decomposition.

For caplets 80 that are about the size and density as the grain, such as the caplets described above, utilizing the dispensing mechanism 100 describe above, it has been determined that one effective dispensing rate for caplets similar to wheat is 568 caplets per second assuming an unloading capacity of 78 liters per second. This dispensing rate yields a relatively uniform concentration of caplets 80 that is not too large so that caplets are wasted or too small so that excessive precautions are necessary to insure a caplet is found during the separation process.

Returning to FIG. 1, initially the wheat producer will report a code or identifier from the caplets 80, the field harvested or to be harvested, and the date the caplets 80 were dispensed to the data retrieval and management system 110. In one embodiment the producer will communicate this information by way of a communications network 120 such as the Internet. Alternatively, the producer establishes direct communication with the data retrieval and management system 110, for example, through a telephone line.

Thereafter, each grain receiving facility, such as elevator 30, terminal/processor 50, export terminal 60, and port 70, will collect caplet information. In one embodiment, a representative sample of the wheat is removed, and the caplets 80 are separated by use of a grain cleaner. In one embodiment, the caplets 80 are recovered using a 4.76 mm ( 12/64″) sieve. The caplets 80 recovered will then be scanned using scanning device 90 and, thereafter, the coded information and possibly additional data will be submitted to the data retrieval and management system 110. In one embodiment, the coded information and data are submitted to the data retrieval and management system 110 by way of a communications network 120. In various embodiments, the network 120 is the Internet or the telephone system. In an alternate embodiment, the scanning takes place at each receiving facility as the grain or other product flows into the facility. In another embodiment, the caplets are automatically scanned without removal of the caplets from the product. This is accomplished by continuously monitoring for either radio frequency signals or bar code recognition. If the automatic scanning does not read a caplet, then a sample can be taken as described above.

The data retrieval and management system 110 stores data from wheat samples and the identification points along the delivery route beginning at the farm field 10 and ending at that point where the wheat exits the marketing system. The system 110 additionally includes a user interface to process queries and provides a reporting capability. In one embodiment, the bar code is an identifying tag which is assigned to a specific producer. This bar code or RFID is used to correlate specific grain varieties, growing treatments, and field locations. Other data can also be tracked such as weather and yields.

In one embodiment, the data retrieval and management system 110 includes a database created in SQL Server 2000 that resides on a server located at a central location. The database includes three tables: one table entitled fields; a second table entitled samples; and a third table entitled locations. The fields table includes attributes for the caplet code, the farm identification, a tract number, a field number, the latitude and the longitude of the field, the country in which the field is located, the grain type, and the date the caplets are dispensed into the grain. The samples table includes attributes for the caplet code, the location where the sample is taken, the date and time the sample is taken, the carrier information, and the country where the sample is taken. The locations table includes attributes for the name, the latitude and longitude, and the address of the location, and the type of the location.

Data entry for the system 110 occurs through a user interface such as a graphical user interface. In one embodiment, the user interface is defined and/or delineated using Visual Basic. In another embodiment, the user interface is defined and/or delineated using Visual C++. Other programming languages will also suffice. In an embodiment, the user interface is downloaded to a computer or other processing device at the site where the information is entered.

In addition to accepting data input from the producer and/or the scanning devices 90, the user interface provides various queries that allow information about samples to be viewed generally or sorted by location, caplet code, or date. In one embodiment, the queries are made using hypertext preprocessor (“PHP”) scripts and output as HTML or PDF documents that are printed on a printing device. In one embodiment, the information is provided on a map, such as the map of a state divided into counties, created as a portable network graphics (“PNG”) image with a PHP script.

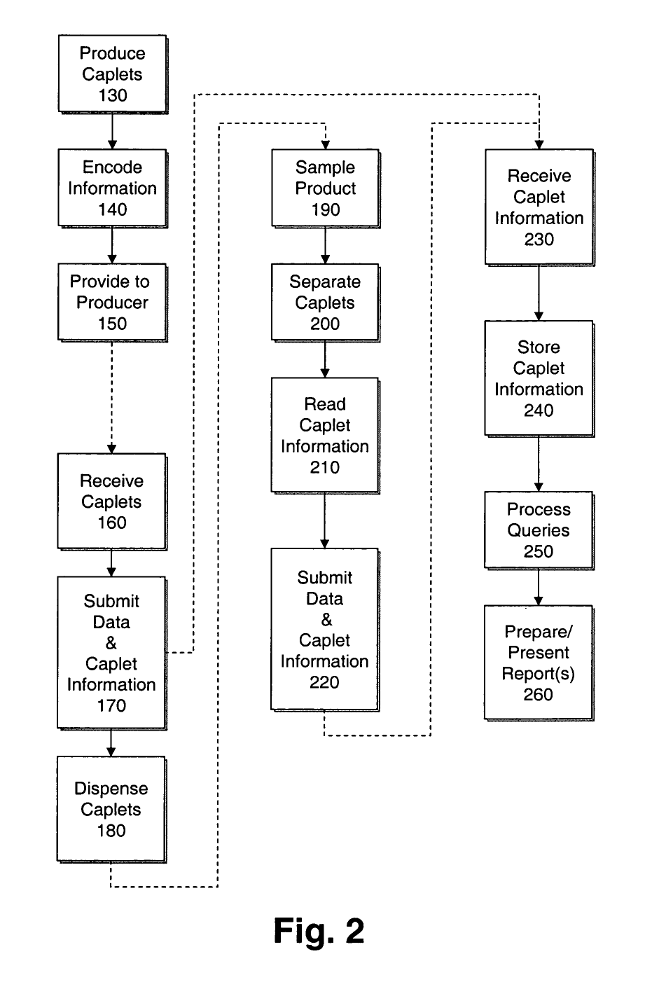

Turning now to FIG. 2, this figure shows a flow diagram that includes various steps of the method of one embodiment of the present invention, and in particular, an embodiment utilizing a bar code inscribed on each caplet. Beginning in box 130, a manufacturer produces the caplets 80. As stated above, the caplets 80 are formed using a die and applying thermal processing and pressure to have a density similar to a wheat kernel so that they will be easily incorporated with bulk wheat grain. Next, in box 140, the caplet information is encoded. In this embodiment, this encoding takes the form of inscribing a bar code on each caplet.

Continuing with FIG. 2, in box 160 the producer receives the encoded caplets 80. Next, in box 170, the producer will coordinate the caplets 80 that will be dispersed into and thereby associated with the product from a particular field 10 and the date that dispersion will occur and submit this data and the caplet information to the data retrieval and management system 110. Once the information is submitted, the method continues in box 180 where the producer or his or her surrogate will dispense the caplets 80 into the appropriate product or, alternatively, the method continues in box 230 as described below.

In box 190, operators at various points in the marketing/distribution process take a sample of the product. In one embodiment, the sample size is 1 liter of product. Next, in box 200, an operator will separate the caplets from the grain, for example by running the sample through a grain cleaner. Following this separation, in box 200, the caplet information is read by a bar code reader, and, in box 220, this information and possibly additional data is submitted to the data retrieval and management system 110. In an alternate embodiment, the product is continuously scanned, and samples are taken only if the automated scan fails to read caplet information.

In box 230, which follows either box 170 or box 220, the data and caplet information is received by the data retrieval and management system 110. Thereafter, in box 240, the data and caplet information is stored, for example in the tables mentioned above. In box 250, the data retrieval and management system 110 responds to any queries posed by either the operator or the producer. Finally, in box 260, the data retrieval and management system prepares and presents if appropriate any reports requested by either the operator or the producer.

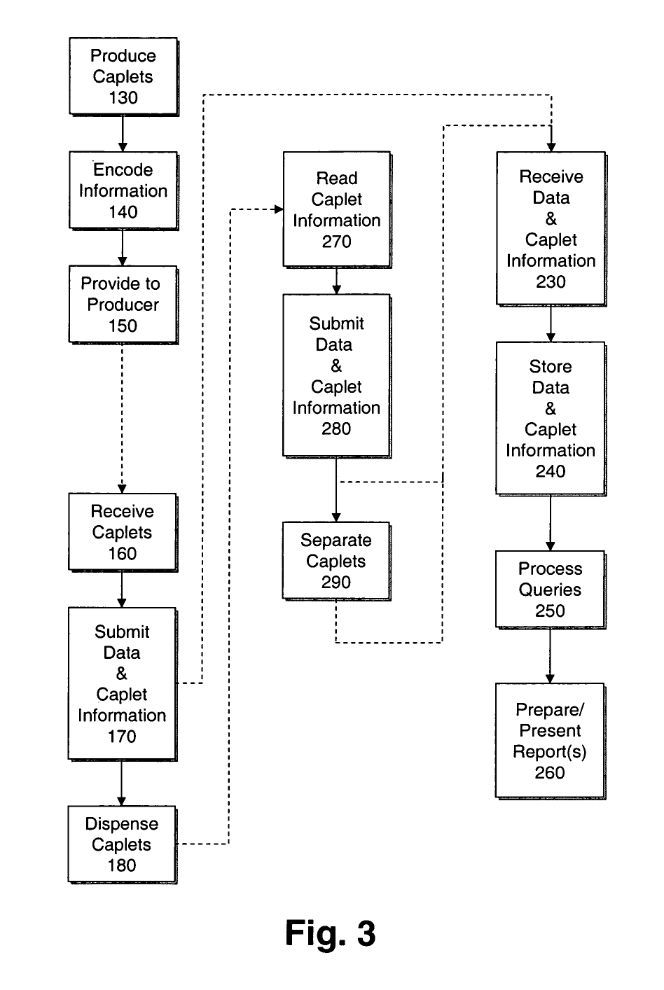

Turning now to FIG. 3, this figure shows a flow diagram that includes various steps of the method of one embodiment of the present invention, and in particular, an embodiment in which the caplet is an RFID tag. As in FIG. 2, this embodiment begins with boxes 130, 140, and 150. Boxes 130 and 150 are the same as in FIG. 2. Box 140, however, is different in that the encoding is accomplished by programming the RFID tag.

The method of this embodiment continues with boxes 160, 170 and 180. These boxes are also the same as in FIG. 2 except that box 270 follows box 180 instead of box 190 as in FIG. 2.

In box 270, the caplet information is read utilizing an RFID scanning device. Unlike in FIG. 2, there is no need to take a sample and separate the caplets in order to read the information. Instead, the RFID tag transmits a radio frequency wave that the scanning device reads from a distance.

After it is read, the caplet information and possibly additional data is submitted to the data retrieval and management system 110 in box 280. Thereafter, the method continues in box 230. Alternatively, if the grain is at the final point in the marketing process and it is deemed appropriate and desirable, then the method continues in box 290 where the caplets are separated from the grain. Box 230 follows both box 280 and box 290 and is the same as in FIG. 2. Likewise, boxes 240, 250, and 260 are the same as in FIG. 2.

Having described the invention, it should be apparent that the invention is both inexpensive and easy to implement and use especially when compared to current identity-preserved tracing programs. Additionally, the system is scalable to large marketing systems and could be used across the entire market for a given commodity. Although the above system and method are described using wheat, as stated above, it will be appreciated that system and method are equally applicable to other commodities. Additionally, from the above description of the invention, those skilled in the art will perceive improvements, changes and modifications. Such improvements, changes and modifications within the skill of the art are intended to be covered by the appended claims.

1. A system for tracing agricultural commodities, the system comprising:
a plurality of tracing caplets, each tracing caplet including encoded information;
a scanning device capable of reading the encoded information on the tracing caplets; and
a data retrieval and management system operable to receive data concerning the agricultural commodity, the data including the encoded information from a tracing caplet, and to store the data.

2. The system of claim 1 wherein the encoded information is contained in a bar code provided on each caplet.

3. The system of claim 2 wherein the scanning device is a bar code reader.

4. The system of claim 1 wherein the tracing caplets are manufactured from food-grade material.

5. The system of claim 4 wherein the tracing caplets are manufactured from wheat material.

6. The system of claim 4 wherein the tracing caplet is manufactured from carbohydrate ingredients.

7. The system of claim 1 wherein each caplet is an RFID tag.

8. The system of claim 7 wherein the scanning device is an RFID tag reader.

9. The system of claim 1 further including a separating device capable of separating the tracing caplets from the agricultural commodity.

10. The system of claim 9 wherein the separating device is a grain cleaner.

11. The system of claim 1 further including a caplet dispensing mechanism operable to dispense the tracing caplets into the agricultural commodity.

12. The system of claim 11 wherein the dispensing mechanism includes a commercially available seed dispenser with fluted-feed grain drill cups and an electrically powered metering mechanism.

13. A method for tracing agricultural commodities, the method comprising:
reading encoded information on a caplet associated with an agricultural commodity; and
communicating the encoded information and additional data about the agricultural commodity to a data retrieval and management system.

14. The method of claim 13 wherein the encoded information is in the form of a bar code, and the reading step comprises utilizing a bar code scanner to read the encoded information.

15. The method of claim 13 further including separating the caplets from the agricultural commodity prior to reading the encoded information.

16. The method of claim 15 further including taking a sample of the agricultural commodity before the separating step and wherein the separating step comprises separating the caplets from the agricultural commodity in the sample.

17. The method of claim 13 wherein the caplet is an RFID tag and the reading step comprises utilizing an RFID tag reader to read the encoded information.

18. The method of claim 13 further comprising encoding the information on the tracing caplets and providing the caplets to an agricultural commodity producer.

19. The method of claim 13 further comprising storing the caplet information and the additional data about the agricultural commodity.

20. The method of claim 19 wherein the caplet information and the addition data about the agricultural commodity are stored in a database.

21. A method for tracing an agricultural commodity, the method comprising:
receiving data concerning an agricultural commodity, the data including the location of the agricultural commodity, and information from a caplet dispensed into the agricultural commodity; and
storing the data and information in a database.

22. The method of claim 21 further including processing queries concerning the agricultural commodity and preparing reports depicting at least part of the data and information about an agricultural commodity.
